(19) United States
(12) Patent Application Publication
(10) Pub. No.: US 2003/0156033 A1
(43) Pub. Date: Aug. 21, 2003

(54) Apparatus and method for assembly, retention and physical protection of radio frequency identification tags for oil drill strings

(75) Inventors: George M. Savage, Grove, OK (US); Bernd H. Strassner III, College Station, TX (US); Kai Chang, College Station, TX (US)

Correspondence Address: FELLERS SNIDER BLANKENSHIP, BAILEY & TIPPENS, THE KENNEDY BUILDING, 321 SOUTH BOSTON SUITE 800, TULSA, OK, 74103-3318, US

(73) Assignee: Paul C. Koomey, Houston, TX

(21) Appl. No.: 10/047,436

(22) Filed: Jan. 14, 2002

Related U.S. Application Data
(60) Provisional application No. 60/261,338, filed on Jan. 12, 2001.

(51) Int. Cl. G08B 13/14

(52) U.S. Cl. 340/572.8; 340/853.1

(57) ABSTRACT

Various means of identifying individual joints of drill pipe or other drill tools have been suggested but have found only narrow utility. Such means include low frequency radio frequency identification systems that are inherently limited by short read ranges and require the reader antenna be placed directly over and very close to an embedded identification tag. With the development of mid-frequency and high frequency systems for radio frequency identification, read distances become much longer and a Gigahertz identification tag has recently been specifically developed for automatic drill string component identification. This invention provides a means for configuring, assembling and providing in-hole protection to a Gigahertz or other radio frequency identification tags.

### CROSS REFERENCE TO RELATED APPLICATION

This application claims priority from copending U.S. provisional patent application Serial No. 60/261,338, filed Jan. 12, 2001, the disclosure of which is incorporated herein by reference.

### FIELD OF THE INVENTION

This invention relates to a means for the assembly, retention and physical protection of a radio frequency identification tag installed in recess holes machined in drill pipe and tools utilized in drilling oil and gas wells.

### BACKGROUND OF THE INVENTION

Drill strings used in oil and gas drilling consist of many different type tubulars and represent a major financial investment. Deep wells often have in excess of 600 joints of drill pipe in the well bore at any given time and in addition to drill pipe, drill strings may include such tools as drill collars, reamers, stabilizers, crossover subs for different threaded connections, safety valves, bit subs, and special logging tools.

A method of automatically identifying, tallying and tracking of uniquely serialized drill string components will be of considerable economic benefit to the oil drilling industry. Based on such an automatic identification system in-hole pipe tallies may be recorded, well depths determined, in-hole component inventories maintained, individual components may be tracked through the well bore, and calculation and measurements of individual component down hole service factors including fatigue wear may be accumulated for each joint. A rarely used method of identification employs a stenciled code stamped on the pipe that is often difficult to locate on the joint and requires the identification to be cleaned, visually recognized, and then manually recorded or entered in a hand-held computer.

Another approach has been using kilohertz radio frequency identification tags as an alternative to stenciling. A tag that has found limited use in drill strings is offered by the Indala Division of the Motorola Corporation who offers their model IT-52E Mini Disc Tag. These small kilohertz frequency tags have dimensions of 11.7 mm diameter by 3.2 mm thick and are normally contained in shallow recess holes machined in the drill pipe.

Kilohertz tags require personnel to locate the tag and often remove drill mud or formation materials off the exposed surface whereby the identification code may be read by hand-held readers that must be positioned directly over the recessed tag at a distance less than a few millimeters. The process of identifying drill pipe by this means is laborious and requires considerable drill rig time that is exceedingly expensive. The requirement of a close read range is largely due to inability of the long wavelengths of the low frequency kilohertz signals to enter into the pipe recess to adequately energize a small tag antenna and has not proved adaptable to automatic identification of drill string components. Kilohertz tags have therefore been primarily limited to asset tracking and inventory control purposes.

To overcome shortcomings of low frequency identification tags, an effort was given to modifying and adapting a longer read range Megahertz system to drill string identification. Following several years work, this effort was abandoned due to the inability to devise a method of the mid-frequency wave length to enter into drill pipe protective recesses sufficiently deep as to transfer energy to the tag antenna to activate electronics and to return an identification code at a read distance necessary for drill string identification.

Longer read distance high frequency identification systems in the Gigahertz ranges are extensively used for applications as automatic vehicle identification and toll collection. These radio frequency identification (RFID) systems include 915 MHz and 2.45 GHz such as supplied by the Amtech Division of Intermec Technologies Corporation of Everett, Wash. A 5.8 GHz system for automatic vehicle tolling is being used in Europe and offered by Q-Free ASA of Trondheim, Norway. Despite good potential for long read distance capability, physical constraints have thus far prevented use of these systems for drill string identification.

Although drill string identification is performed on the rig at atmospheric pressures and ambient surface temperatures, electronics must be protected against down-hole pressure that may reach 25,000 psi and the electronic components must be able to survive occasional 450° F. bottom hole temperatures. In addition to isolating the electronic circuitry from high well bore pressure and drill fluids, tags require physical protection such as required when pipe is being transported, handled on pipe racks, being made up in or broken out of mating drill string threaded joints with heavy duty tongs, and for the abrasion and pounding against the geologic formation walls while rotating the drill bit in the hole or traversing the well bore.

High well bore pressures will quickly and permanently disable electronics unless they may be isolated and protected and Gigahertz frequency systems antennas are typically a plate or patch that is too large to protect against well bore conditions and damage. A need, therefore, exists for a means to isolate and protect a Gigahertz frequency system and antenna from such high well bore pressures. It is an object of this invention to include a means for the installation and protection from physical damage of a Gigahertz frequency circular patch antenna in a tag assembly whereby protection in the well bore is provided for tag electronics at essentially atmospheric pressure. This invention is not limited to a Gigahertz frequency and mid-frequency and low-frequency identification tags with loop or coil antennas may also employ the features of this invention.

### SUMMARY OF THE INVENTION

This invention provides a means of configuring a drill string identification tag in a manner whereby the tag electronic circuits are retained at near atmospheric pressure and isolated from destructive well-bore pressures while the tag antenna may be subject to high well bore pressure and abuse common to oil and gas well drilling operations. Other features of this invention include relative ease of tag assembly at the time of manufacture and simplicity of installation of a tag assembly in a drill string component. One embodiment of this invention permits protection of relatively large electronic circuitry and employs a metal protective housing assembly. An alternative embodiment anticipates the use of the electronic circuits being contained in a millimeter dimensioned integrated circuit, or ASIC, protected by a ceramic or composite material. This alternative configuration may be less expensive and offers the advantage of permitting recovery of an intact tag assembly from the drill string protective recess as desired for tag reinstallation in another drill string component or for tag replacement in event of a malfunction.

Both embodiments of the tag assembly are to be contained and protected within an approximate 1″ diameter recess hole machined into a heavy wall section of a drill pipe tool joint, drill collar, sub, stabilizer or other down-hole drill string component. The drill string component protective recess hole is drilled sufficiently deep to contain the overall height of the tag assembly and includes an electromagnetically conductive sacrificial plastic wear material extending from the antenna to be flush with the outside diameter of the component. The thickness of the plastic protective material is intended to permit component wear from a new outside diameter to a pre-determined worn diameter usually specified by an American Petroleum Institute standard. The tag wear and protection is of a plastic type material that has a low dielectric constant to minimize radio frequency signal attenuation, is resistant to chemicals and fluid adsorption, and has a satisfactory temperature and strength capability. One such material that satisfies these requirements is a Teflon® compound.

The Electromagnetics and Microwave Laboratory of Texas A&M University Department of Electrical Engineering has recently completed the development of 5.8 Gigahertz frequency tag circuitry specifically designed for drill string identification. Wave lengths of a 5.8 Gigahertz frequency have been demonstrated to be sufficiently short to allow entry down into a drill pipe protective recess so as to communicate with and impart energy to a small circular patch antenna of an identification tag. In this development, microwave frequency passive backscatter identification system electronics have been built and tested that are capable of identification reads through drill mud films to a recessed tag and which has heretofore been considered impractical and untried for drill string identification. Texas A&M University intends to license the technology for drill string identification through their Technology Licensing Office and a Formal Patent Application titled “System and Method for Communicating Information Associated with a Drilling Component” has been filed with a date of Jul. 16, 2001 Ser. No. 09/906,957. This communications technology offers one means of enabling radio frequency automatic drill string identification and makes practical the applications and benefits described in the Savage U.S. Pat. No. 5,202,680.

This invention is well suited for the newly developed Texas A&M University technology which thus far has utilized electronic circuits composed of one or more etched circuit boards on which are mounted various electronic components. One embodiment of this invention utilizes a metal tag housing to protect these relatively large electronic circuits at essentially atmospheric pressure. An alternative embodiment of this invention consists of tag housing of a ceramic or composite material retaining and protecting a small integrated circuit at atmospheric pressure. One such non-metallic tag housing material is Alumina Oxide that has a compressive strength of approximately 375,000-pounds/square inch that is adequate considering the available wall thickness of the ceramic protection.

Coaxial antenna leads are required for high frequencies and one or more leads must penetrate the ceramic or metal from the electronics enclosure to the antenna remote from the circuitry. The embodiment of this invention that utilizes the ceramic or composite circuit housing and antenna may be encapsulated by a plastic type material for the purpose of protecting, cushioning and retaining a fragile ceramic or composite housing within the component recess. It is intended the same encapsulation material will provide sacrificial wear and a residual cover over the tag assembly as the drill string component is worn to an allowable minimum outside diameter.

In the embodiment of the metal tag housing, the coaxial lead wire may be pressure sealed from the electronics chamber by means of a low expansion conductor wire used in conjunction with compatible glass, ceramic or composite material characteristics. The antenna lead wire is thereby insulated from the metal tag housing as to form a coaxial antenna lead required for high frequencies. Several sources offer glass-to-metal sealing low expansion wire such as Dumet or Kovar and include Ed Fagan Inc. 769 Susquehanna Ave., Franklin Lakes, N.J. 07417. Glass suitable for use with these alloys to insulate and seal antenna leads is available as Corning 7052 or 7050, Kimble EN-1 and others. Similar capability ceramic-glass is an Alumina Oxide available from several sources that include LTD Ceramics Texas, 12122 Technology Drive, Austin, Tex. 78727.

Pressure seal of coaxial antenna leads for the alternative embodiment ceramic or composite tag housing may be accomplished in a similar manner as for the metal tag housing except a small metal tube or wire braid will replace the function of the metal of the tag housing and serve as the outer coaxial conductor. The outer conductor tube or wire braid of the coaxial lead may contain the glass, ceramic or composite insulated and sealed inner wire and may then be placed in the tag housing through a drilled hole of a machined tag housing or else during forming of housing segments prior to sintering or curing the materials. As this alternative non-metallic housing allows installation of a coaxial lead in the ceramic or composite at the time of housing manufacture, the coaxial leads may be a curved or irregular shape connecting the integrated circuit electronics and the antenna to accommodate differences in antenna lead and electronic circuit spacing.

It is intended the features of this invention will not be limited to a 5.8 GHz frequency but may be used with other Gigahertz, Megahertz and kilohertz frequency tag assemblies and antenna configurations.

### BRIEF DESCRIPTION OF THE DRAWINGS

FIG. 1 is a drill pipe tool joint pin end illustrating an identification tag protective recess hole containing an RF identification tag assembly.

FIG. 2 is an exploded view of an identification tag assembly.

FIG. 3 is a partial cross-section of a drill pipe tool joint pin end with an identification tag assembly in the tool joint protective recess.

FIG. 4 is a partial cross-section of a drill pipe tool joint pin end illustrating an alternate location of the tag assembly seat in the recess.

FIG. 5 is a partial cross-section of a drill pipe tool joint pin end with an identification tag integrated circuit protected in a ceramic housing.

### DESCRIPTION OF THE PREFERRED EMBODIMENT

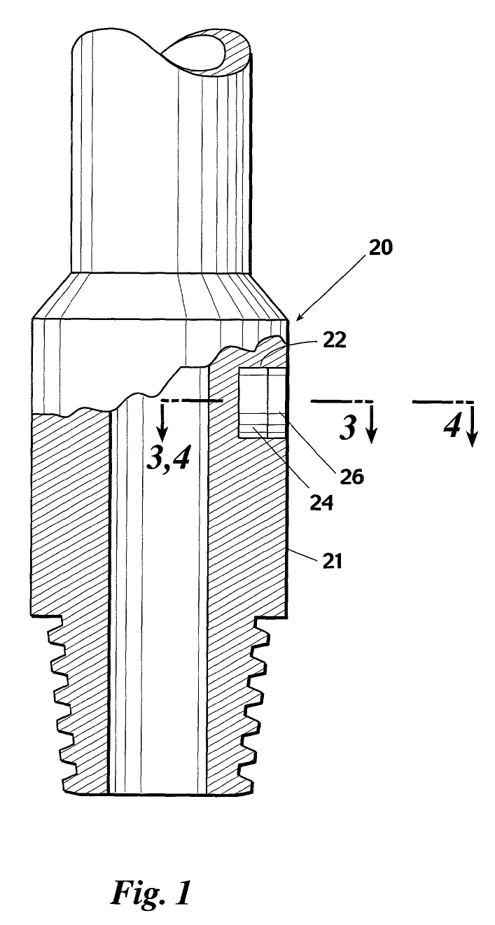

Referring to FIG. 1, the pin end of a drill pipe tool joint 20 has an approximate 1″ inside diameter protective recess hole 22 drilled to retain and partially protect radio frequency identification tag assembly 10. The recess hole is drilled to a depth that provides tag protection throughout the useful service life of the tool joint and until the outside diameter of the tool joint is worn in well bore service to a predetermined reduced diameter that maintains joint structural integrity.

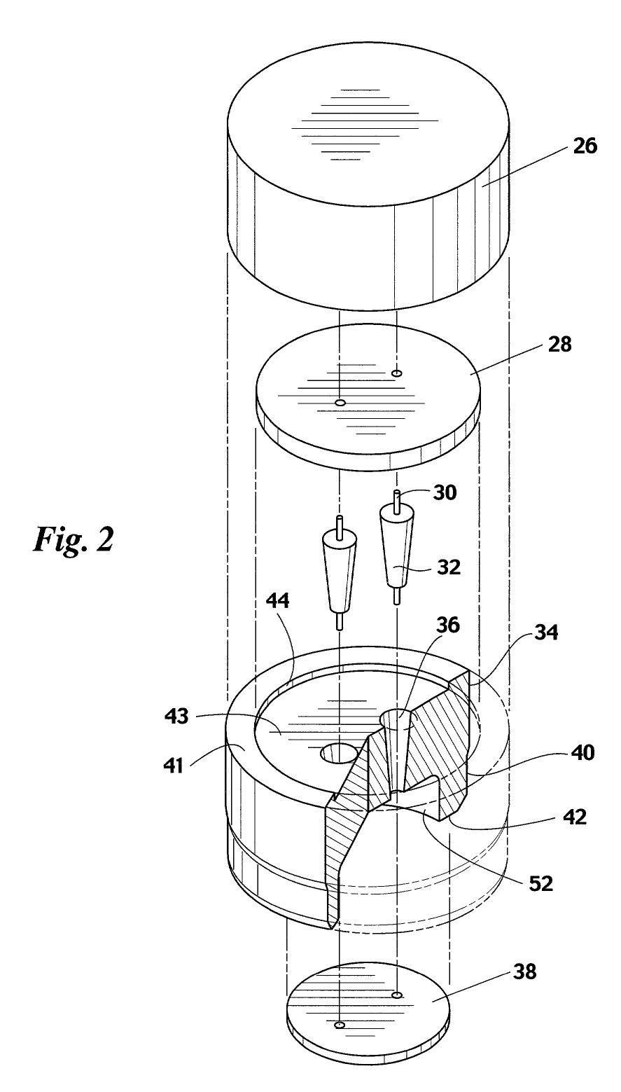

Now referring to FIG. 2, an exploded view of one embodiment of the tag illustrates complete tag assembly 10. Tag assembly 10 includes low dielectric constant electromagnetically conductive plastic type protective material 26. Tag antenna 28 may be in the form of a coil or loop but for a microwave frequency such as 5.8 GHz will be a circular patch over substrate and ground plane layers. A shallow recess 44 having approximately the same inside diameter as the patch antenna substrate and ground plane outside diameter is provided in the tag housing 34 to position and help retain the antenna in said tag housing. One or more antenna leads 30 are contained within ceramic, glass or composite material insulation 32 to effect a coaxial connection through the tag housing to tag electronic circuits 38. The coaxial antenna lead insulation 32 is of a truncated cone shape such that the tag assembly 10 in this embodiment forms a tapered plug which will provide an initial seal against well bore pressure. Specifically, in the presence of high well bore pressure, a substantial force is applied to the tapered plug thereby wedging and increasing tightness (retention in the drill pipe protective recess 22) and sealing capability.

Continuing with reference to FIG. 2, the outside diameter of the metal tag housing 34 is dimensioned to provide an interference fit with the pipe protective recess inside diameter 23 and enable a metal-to-metal seal for isolating the tag electronics against well bore pressure and to retain the tag assembly in protective recess 22. A section of slightly reduced outside diameter 40 of tag housing 34 facilitates insertion and installation of tag assembly 10 in the protective drill string recess 22. A secondary metal-to-metal seal of the electronic circuitry against well bore pressure is provided by tag shoulder 42 seating on the bottom 25 (FIG. 1) of the drill string component protective recess 22. This seal is made more effective as well bore pressure acting on the projecting area 41 of tag assembly 10 results in a large force being exerted against the projecting area 41 of said tag shoulder 42 so as to produce a high unit contact pressure that will effect a metal-to metal seal with the bottom 25 of the protective tool joint recess 22.

Tag housing 34 includes a proximal surface and a distal surface. The proximal surface of tag housing 34 is positioned adjacent antenna 28 and sacrificial wear material 26. Tag electronics 38 are positioned adjacent to the distal surface of tag housing 34.

With further reference to FIG. 2, the plug of plastic type protective and sacrificial wear material 26 fills the protective recess 22 (FIG. 1) above the proximal surface of tag housing 34 and tag antenna 28 so as to be flush with the outside diameter surface 21 of the tool joint 20. The sacrificial plastic material 26 prevents drill mud or geological formation materials from filling the space above tag antenna 28 thereby attenuating identification signals and also serves to buffer the tag assembly 10 against in-hole damage or during handling on the drill rig. The sacrificial wear material 26 wears with the drill string component outside diameter 21 (FIG. 1) and is an electromagnetically conductive plastic type material having a low dielectric constant. If a coil or loop antenna is employed rather than the patch antenna 28 of the preferred embodiment, an antenna standoff above an electrically conductive tag housing will be necessary and said coil or loop antenna will be then contained in the protective and wear plastic material 26.

Although it is understood that alloy steel might be employed, in the preferred embodiment of the metal tag housing 10, a high strength material having a low Young's Modulus is employed. One advantage of a low Young's Modulus material is in minimizing the force required to install and seat tag housing 10 into the interference fit of the component recess 22. Another feature/benefit of a low modulus material is that as the drill string component recess 22 distorts due to high service induced stresses, the elasticity of a low Modulus material enables the diameter of tag housing 34 that has been compressed due to the interference fit to recover and contribute to maintaining a metal to metal pressure seal. A material well suited for tag housing 34 in the preferred embodiment is Titanium which has a Young's Modulus of approximately one half that of steel, is resistant to corrosion, has a coefficient of thermal expansion approximating that of steel and may be alloyed to provide the high yield strength needed to minimize the tag housing dimensions. An additional feature of titanium, separate and apart from the low Young's Modulus is that Titanium alloys have a high Poisson's Ratio (approximately 0.36) such that when high well bore pressure is transmitted through the plastic protective material 26 to the projected exposed surface area 43 of the tag housing, the compression force and strain will tend to elastically expand the diameter of tag housing 34 and exert an additional radial contact and sealing force against the wall of the protective recess 22. One such Titanium alloy in common use that satisfies these requirements is Ti-6AI-4V.

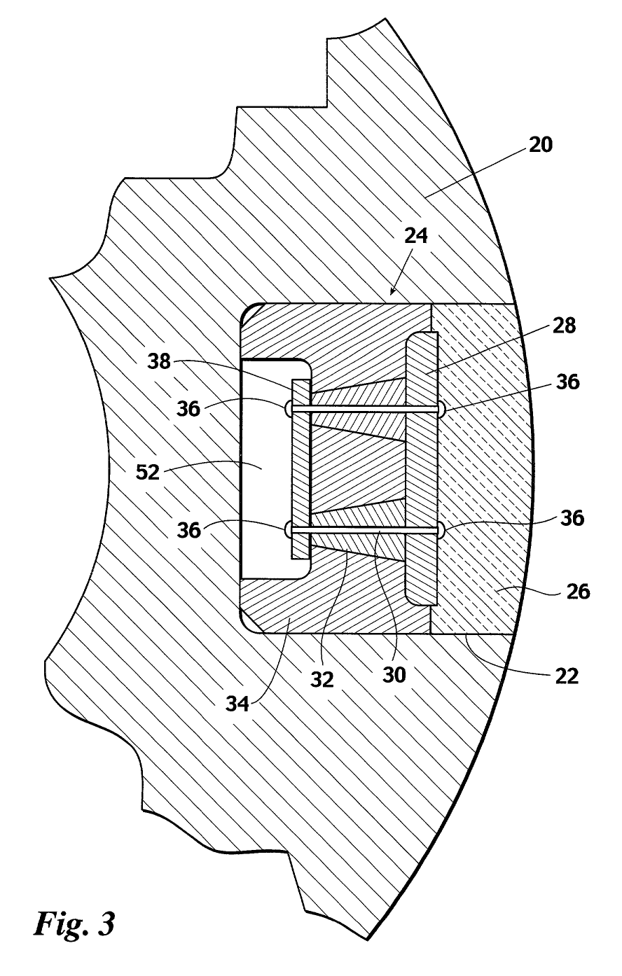

Referring next to FIG. 3, this illustration represents a partial cross-section of the tool joint 20 and shows the metal tag housing assembly 10 in place within the drill string component recess hole 22. Said metal tag housing 34 contains one or more ceramic or composite material truncated cones 32 to insulate the wire antenna lead(s) 30 as to form a coaxial antenna lead whereby the metal housing serves as the outer coaxial conductor. The tag assembly 10 rests on the bottom 25 of the recess hole 22 and contains cavity 52 machined to accommodate tag electronics 38 which may be in the form of an integrated circuit or a circuit board on which are mounted electronic components. High temperature solder joints 36 connect coaxial antenna leads 30 to the antenna 28 and the electronic circuits 38. This tag configuration enables and facilitates tag assembly and manufacture including accessibility to solder joints and the means of placement and installation of the electronic circuits 38.

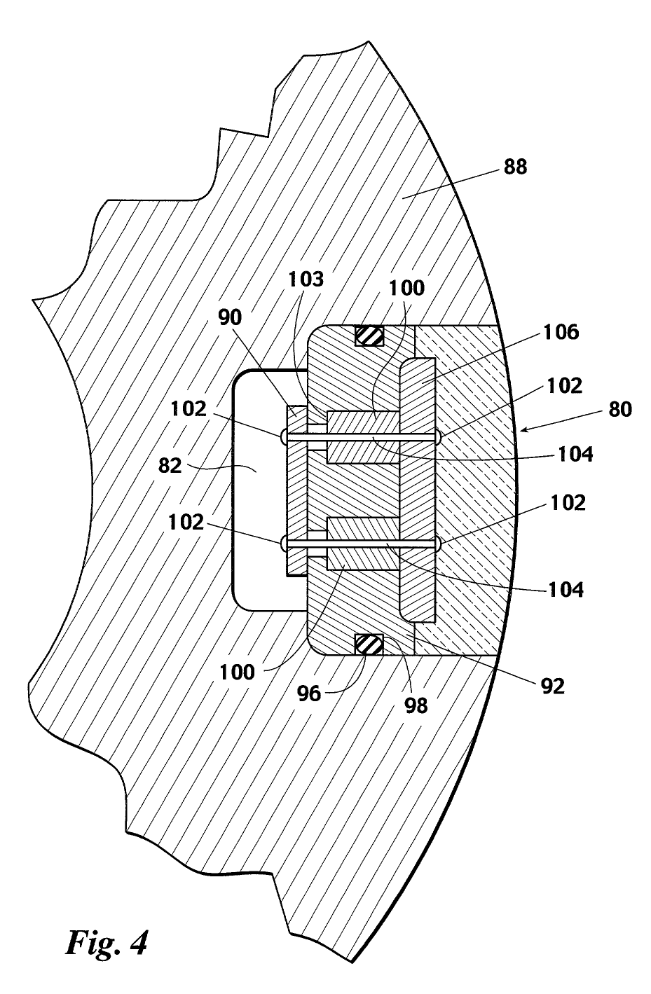

Reference is next made to FIG. 4 which is an alternate embodiment 80 of the metal tag housing of the present invention. Alternate embodiment metal tag housing 80 does not contain an electronics cavity (52 in FIG. 3) in the metal tag housing but instead the electronics cavity 82 is formed by a reduced hole diameter machined into the bottom 86 of the protective recess 86 of the drill string component 88. The electronic circuitry 90 in the form of circuit boards or an integrated circuit continues to be attached to the underside of the alternative shape tag housing 92. The alternate embodiment tag housing 92 lands on recess shoulder 94 to provide a supplementary metal-to-metal seal when under high well bore pressure and contact force(s). In addition to an interference fit of tag housing 92 in protective recess 84, a secondary elastomer pressure seal 96 retained in seal groove 98 may also prevent down-hole pressure and fluids from accessing electronics cavity 82. As tag housing 92 has relatively little overall height and provides limited space for a reduced lower end diameter, to assist in insertion of tag housing 92 into protective recess 84 a short section of the of the component recess 84 aperture may be tapered to a slightly larger inside diameter to introduce metal tag housing 92.

Still referring to FIG. 4 an alternative embodiment of the glass or ceramic antenna lead coaxial cable insulation (32 of FIG. 3) is replaced with cylindrical shaped insulation (collectively 100) fabricated of similar materials as the truncated cone 32 illustrated in FIG. 3. A shoulder 102 in tag housing 92 seats and limits travel of the cylindrically shaped antenna lead insulator 100 and prevents pressure from forcing the cylindrical shape through the tag housing 92. The pressure seal between the cylindrical hole drilled through the tag housing 92 (to accommodate cylindrical insulator 100) and the cylindrical insulator 100 will be by means of a high temperature sealant (available commercially) inserted at the time of manufacture.

Additional or alternative seals used to seal metal tag housing 92 inside protective recess 84 and against well bore pressure may include a metallic gasket placed between the mating recess shoulder 94 and the tag housing 92. Although drill mud hydrostatic heads will hold the tag assembly 80 firmly in place when in the well bore, during surface handling of drill string component 88, the identification tag assembly 80 can be further retained in protective recess 84 by additional methods to the preferred press or interference fit and include (but are not limited to) coining, a section of a fine pitch thread for the tag housing and mating recess, a threaded hold-down nut, or by a bonding material.

The embodiments of a metal tag housings (34 and 92) as illustrated in FIGS. 2, 3, and 4 are well adapted to relatively large electronic circuitry mounted on a circuit board as developed by the Texas A&M University for the above-described prototype tags. Upon substitution of the circuit board construction method with an integrated circuit, or ASIC, that has physical dimensions of only a few millimeters, a ceramic or composite material tag housing can offer the protective features of a metal housing and may have an advantage in housing fabrication costs will also enable a means of recovery of the tag housing assembly (34 or 92) from the component recess (22 and 84, respectfully).

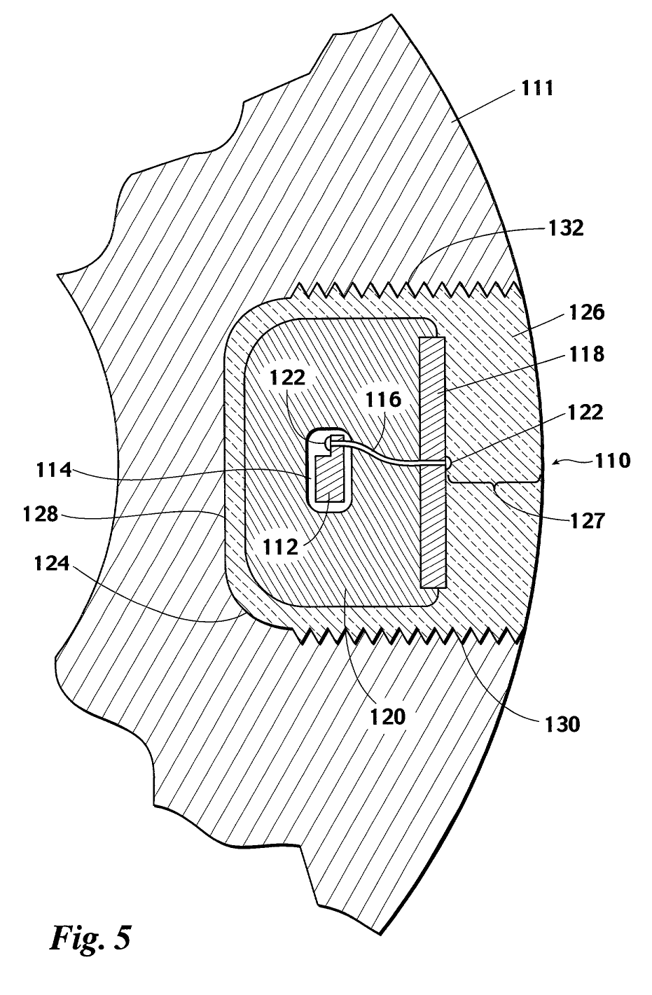

Referring now to FIG. 5, the tag housing 120 of this embodiment is a ceramic or composite material in which integrated circuit 112 is situated in housing electronics cavity 114. Tag housing 120 is of a material having the high compression strength required for high bottom hole pressure protection and may be of various ceramic materials or composites including the glass-ceramic Alumina Oxide. The ceramic or composite tag housing 120 of this embodiment may be machined from solid stock or formed of powdered materials and sintered in upper and lower segments. One or more prefabricated coaxial leads 116 that will connect integrated circuit 112 to the tag antenna 118 and will be inserted through hole(s) drilled in the tag housing segment 120 or alternatively be placed in the powdered material during forming of the segment and will be sealed during sintering or curing of the tag housing material. The tag integrated circuit 112 is then installed and connected with high temperature solder joint 122 to the one or more coaxial antenna lead(s) 116. The segments of the tag housing are subsequently joined and sealed by a solder glass, high temperature bonding agent, brazing metal or similar means and the tag antenna 118 attached and connected with high temperature solder. The shape of the alternative embodiment ceramic or composite tag housing 120, designed to withstand high pressure, will ideally be of an approximate cylindrical shape along its length and will permit a large radius 124 at the juncture of the wall of recess 130 and recess bottom 128 that serves to reduce stress concentration factors in this area of the drill string component 111.

After assembly of the tag housing 120, to include tag antenna 118, a layer of a low dielectric constant electromagnetically conductive plastic material 126 surrounds and encapsulates the ceramic alternate embodiment tag housing 120 to cushion and adsorb shock because some housing materials are often brittle and subject to fracture, compensate for differences in coefficients of thermal expansion and protect from component stress induced strains. A thicker section 127 of plastic material 126 is an integral part of the plastic encapsulation and will extend to fill the volume above the tag antenna to be flush with the outside diameter of drill string component 111 and provide a wear volume and a buffer for protection against well bore pounding and rubbing against the walls of the hole, drill pipe tong teeth indentations and deformation and for handling damage on the surface pipe racks or during shipping.

Plastic encapsulation material 126 will be bonded to tag housing 120 and the entire assembly 110 will be anchored and retained in protective recess 130 by means of a fine thread, or “v” or “u” shaped grooves 132 in the wall of component recess 130. Some tag electronics (such as 112) and fields of antenna 118 may be polarized and require a specific orientation of the antenna 118 in the protective recess 130 in relation to the axis of drill string component 111 so that tag 110 can be read by fixed interrogator system antennas (not shown). Positive and firm bottoming out (as shown in FIG. 5) of the tag 110 in the component protective recess 130 is required and the orientation of tag 110 is dependent on threads 132 and screwing assembly 110 in recess 130 will be difficult and happenstance. Therefore, an interference fit plastic encapsulation, a bonding material that bonds to the plastic encapsulation, or a combination of both (collectively shown as 126) will be the preferred tag retention and anchoring method.

Removal of tag assembly 110 for replacement or reuse may be accomplished by means of a hole saw drilling out encapsulation material 126 between tag housing 120 and the wall of the component recess 130. New or additional plastic encapsulation material 126 may then be bonded to the recovered tag 110 to replace the material removed in salvaging the tag and the tag 110 is reinstalled as desired.

While the above description contains many specifics, they should not be construed as limitations on the scope of the invention, but rather as an exemplification of the preferred embodiments and applications thereof. It is intended the foregoing embodiments and features to be applicable to other identification tag applications requiring the features and the protection offered by this invention.

What is claimed is:

1. An apparatus for retention and protection of a radio frequency identification tag in a recess having a bottom in an oil drill string, comprising:
a tag housing press fit into the recess in the oil drill string;
said tag housing having a proximal surface and a distal surface wherein said distal surface is adjacent the bottom of the recess;
a tag electronic circuit positioned adjacent said distal surface of said tag housing;
a tag antenna positioned adjacent said proximal surface of said tag housing;
at least one antenna lead extending from said tag electronic circuit to said tag antenna;
a plug of protective material positioned adjacent said proximal surface of said tag housing covering said tag housing and said tag antenna.

2. The apparatus of claim 1 wherein said tag housing is constructed of a material having a low Young's Modulus.

3. The apparatus of claim 2 wherein said tag housing is constructed of titanium.

4. The apparatus of claim 1 wherein said tag housing is constructed of ceramic.

5. The apparatus of claim 1 wherein said plug surrounds and encapsulates said tag housing.

6. The apparatus of claim 5 wherein said plug further surrounds and encapsulates said tag antenna.

7. The apparatus of claim 1 wherein said plug is an electromagnetically conductive material.

8. The apparatus of claim 7 wherein said plug is an electromagnetically conductive plastic type material.

9. The apparatus of claim 8 wherein said plug is an electromagnetically conductive plastic type material having a low dielectric constant.

10. The apparatus of claim 1 wherein said antenna is a patch antenna.

11. The apparatus of claim 1 wherein said antenna is a coil antenna.

12. The apparatus of claim 1 wherein said at least one antenna lead extends through said tag housing.

13. The apparatus of claim 1 wherein said at least one antenna lead includes insulation thereon thereby insulating said at least one antenna lead from said tag housing.

14. The apparatus of claim 13 wherein said insulation is of a truncated cone shape and said tag housing includes at least one truncated cone shaped receiver shaped to receive said at least one antenna lead having said truncated cone shaped insulator thereon.

15. The apparatus of claim 13 wherein said insulation is of a cylindrical shape and said tag housing includes at least one cylindrically shaped receiver shaped to receive said at least one antenna lead having said cylindrically shaped insulator thereon.

16. The apparatus of claim 1 wherein said distal surface of said tag housing includes a cavity therein to receive said tag electronic circuit.
